(19) United States
(12) Patent Application Publication
(10) Pub. No.: US 2005/0178349 A1
(43) Pub. Date: Aug. 18, 2005

(54) Multi-fueled internal combustion engine

(76) Inventor: Kwong Wang Tse, Hong Kong (CN)

Correspondence Address: BURNS DOANE SWECKER & MATHIS L L P, POST OFFICE BOX 1404, ALEXANDRIA, VA, 22313-1404, US

(21) Appl. No.: 10/778,117

(22) Filed: Feb. 17, 2004

(51) Int. Cl. F02B 75/18

(52) U.S. Cl. 123/52.2

(57) ABSTRACT

An internal combustion engine including at least two engine cylinders, and each cylinder can process its own four-stroke cycle of fuel intake, compression, combustion and exhaustion with an open/shut device in between two adjacent cylinders. Fuels in different cylinders or different parts of a cylinder combust together as the open/shut device is opened at combusting time. Each cylinder is consuming different fuels, non-flammable liquid or gas, and water as a fuel for making use of the high temperature and pressure of the combustion of one fuel to dissociate the other fuel or non-flammable fuel into its original flammable elements by burning and combusting in high temperature and pressure. This engine cylinder configuration substantially increases the utilization of fuel and different kinds of fuels to enhance the advantages on flexible, economical, and environmental considerations.

### FIELD OF THE INVENTION

This invention relates to internal combustion engines and, more particularly, to internal combustion engines which consume more than one fuel. More specifically, this invention relates to an internal combustion engine of the four-stroke type with more than one cylinder to consume more than one fuel.

### BACKGROUND OF THE INVENTION

Internal combustion engines are widely used as power plants for many types of equipment and apparatuses such as automobiles, power generators, pumps, compressors, ships, tractors, machines, and airplanes. In order to supply adequate power and considering economic conditions, many kinds of fuel are consumed in the world such as petroleum, diesel, kerosene, liquefied pressured gas, natural gas, methane, alcohol, plantation oil, hydrogen, oxygen, and engine emission. More specifically, this invention relates to an internal combustion engine having different cylinders to consume different fuels.

In general, an internal combustion engine consumes one type of fuel based upon its power, economics, supply and engine type. Petroleum fuels that run most engines in the world are earth minerals with no chance to be created from machine or plantation production. Any earth mineral will come to an end and that would be the time that most engines in the world should come to a stop, when petroleum is finally finished by years of drilling. Petroleum fuels are widely used for their special characteristics. My invention enables an internal combustion engine to have a replacement fuel, or be partly replaced by other fuels.

In addition, many internal combustion engines and my invention are made of steel, wrought iron or other ferrous or non-ferrous metal alloys and have a four-stroke cycle: 1) fuel intake, 2) compression, 3) combustion and 4) exhaustion. Engine designers endeavor to have efficient, economical and environmental engines and fuels, but most engines can consume only one fuel. When the price and supply of that fuel is changing dramatically in the market, every engine of this kind of fuel has no way to swap to another fuel for economical considerations. In addition, pure water is not a fuel, but water consists of hydrogen and oxygen, and both elements are flammable in their natural states. Many scientists believe water would the future fuel for all engines as it has unlimited supply on earth. My invention may be the first practicable design in the world to bring water to be a fuel. Hence, it will be highly beneficial if there can be provided an improved internal combustion engine or engine topology which can overcome or at least mitigate the short-comings associated with the afore-said disadvantages or bring in advantages to conventional and non-conventional internal combustion engines.

### OBJECT OF THE INVENTION

Hence, it is an object of the present invention to provide an improved internal combustion engine or engine topology to overcome or, at least, mitigate disadvantages, or bring in advantages associated with conventional and non-conventional internal combustion engines. More specifically, it is an object of the present invention to provide an improved internal combustion engine or engine topology which serves to improve engine performance to take more than one fuel, permit easy swap of fuel, and utilize non-flammable liquid or vapor and water as a fuel in an engine operation. As a minimum, it is at least an object of the present invention to provide the public with a choice of a novel internal combustion engine or engine topology to be described hereinafter.

### SUMMARY OF THE INVENTION

In view of the aforesaid objectives and according to the present invention, there is provided an internal combustion engine including at least two engine cylinders, each said cylinder consuming a different fuel. One cylinder consumes a regular fuel in its four-stroke cycle, but in its combustion process, its explosion generates high heat and pressure to ignite or burn the other fuel in the other cylinder, causing a simultaneous combustion of two cylinders. In the invention there are two or more cylinders, working the same four-stroke cycle in different cylinders on their own fuel, but in their combustion strokes, a door between the cylinders is opened for simultaneous combustion. Then the door in between them is closed for other strokes until a simultaneous combustion is ready to happen again.

Preferably, the engine can take two fuels instead of relying on one. The non-regular fuel can be swapped to other fuels easily, as their combustions are not ignited by their sparks, but by simultaneous combustions of the other fuel—the regular fuel.

Preferably, if the engine has four cylinders for its four-stroke process for a regular fuel, four other cylinders for non-regular fuel can have up to four different fuels.

Preferably, because of the high heat and pressure of the combustion of the regular fuel in the engine, it is not only able to combust the first fuel but to dissociate or deform the chemical combination of the other fuel in the other cylinder into its original elements. This combustion process not only burns the other fuel, but also turns the other non-flammable gas and vapor into their flammable original elements that burn by this dissociation process, for example: carbon dioxide, carbon monoxide, hydrocarbon, and water vapor.

Preferably, the engine further makes use of the simultaneous combustion process to turn the engine emission or waste into burning fuel.

Preferably, the engine further makes use of the high heat and pressure of burning hydrogen at about 2,300-3,000 degrees C. as a regular fuel, to combust water, steam or water vapor into a burning fuel.

Preferably, as hydrogen and oxygen are the only elements of water, they can be obtained from hydrolysis by mechanical, electrical and chemical processes on water. The invention can be run by water as the fuel by a cycle of hydrolysis, burning and running. For example, an internal combustion engine fueled by hydrogen and water can operate with the following cycles—combust the internal combustion engine—working routine and producing electricity—electricity to hydrolyze water—produce hydrogen to run the engine with water again.

### BRIEF DESCRIPTION OF THE DRAWINGS

Preferred embodiments of the present invention of a multi-fueled internal combustion engine or engine topology will be explained in more detail in the specific description below by way of examples and with reference to the accompanying drawings in which:

FIGS. 1a to 1d show simplified schematic diagrams of a multi-fueled internal combustion engine illustrating the principle of the operation of two fuels intake, compression, combustion and exhaustion of a first embodiment on a pair of cylinders of the present invention, in a complete engine cycle running on a conventional internal combustion engine;

FIG. 2 illustrates a sample of the invention for three cylinders which utilize three fuels;

FIG. 3 illustrates an example of the invention for a non-conventional internal combustion engine based upon my previous invention of an internal combustion engine of U.S. patent application Ser. No. 10/123,402;

FIGS. 4a-4e correspond to FIGS. 8a-8e of my prior application.

FIG. 5 illustrates an example of the invention for a small internal combustion engine based upon my previous invention of an internal combustion engine of U.S. patent application Ser. No. 10/123,402;

FIG. 6 corresponds to FIG. 2 of my prior application; and

FIG. 7 illustrates an example of the cycle of working using water as the fuel.

### DETAILED DESCRIPTION OF THE PREFERRED EMBODIMENTS

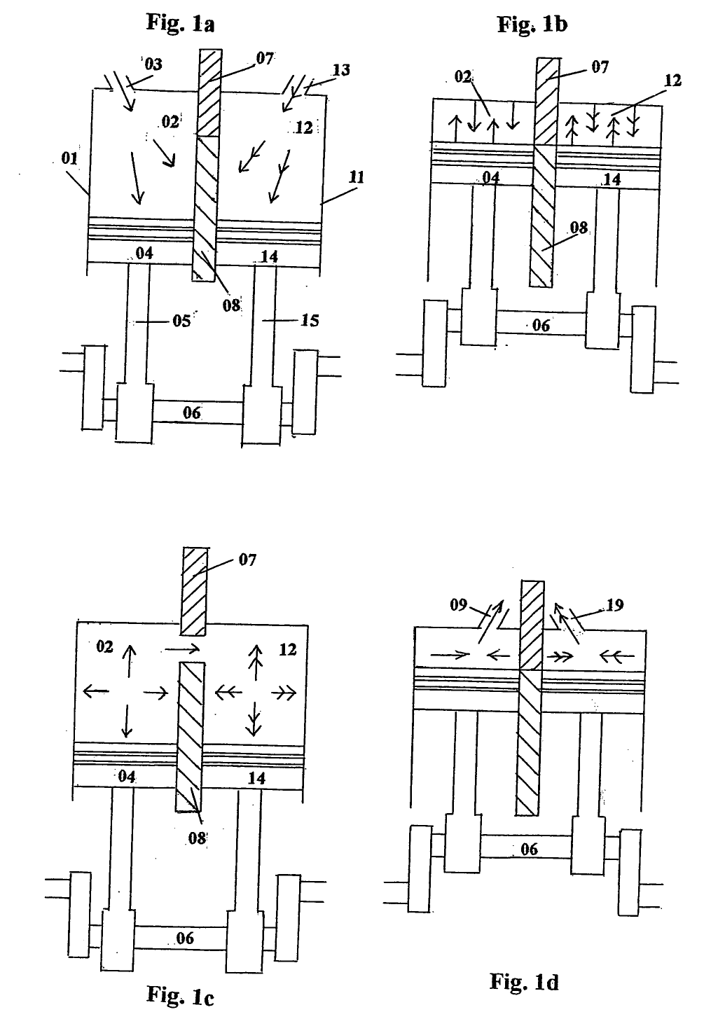

Referring first to FIGS. 1a to 1d, there are shown simplified sketches of a first preferred embodiment of the present invention comprising a pair of cylinders in a conventional internal combustion engine. The figures show a series of engine operating movements to illustrate the general principles of operation of the present invention. The engine generally includes at least two cylinders, although a plurality of engine cylinders may be, and are generally, connected together to meet with specific power and operation requirements and to fulfill various performance criteria.

Cylinder (01) generally includes a combustion chamber (02) with a fuel intake aperture (03). The piston member (04) is connected to a connecting rod (05) holding a crankshaft (06) below. The cylinder (01), including the combustion chamber (02), the piston member (04), connecting rod (05) and crankshaft (06), is preferably made of steel, wrought iron or other rigid metal alloys, both ferrous and non-ferrous, suitable for engine making. Adjacent to cylinder (01), cylinder (11) is built next, and includes a combustion chamber (12) with a fuel intake aperture (13). Cylinder (11) has its piston member (14) with its connecting rod (15) holding the same crankshaft (06) below. Two cylinders (01, 11) are separated by an open/shut device with an opening part (07) at the top and a permanent part (08) at the bottom that prevents the two cylinders (01, 11) from communicating with each other when it is shut.

FIG. 1a shows that different fuels (represented by single arrows and double arrows, respectively) are taken into the two cylinders (01, 11) from their own intake apertures (03, 13). FIG. 1b shows, by the working of the common crankshaft (06) with two pistons (04, 14), that fuels in combustion chambers (02, 12) are compressed at the same time by the working of pistons (04, 14) and the common crankshaft (06) system. FIG. 1c shows the first fuel in combustion chamber (02) is ignited and combusting. The open/shut device is working simultaneously with the top opening (07) being opened. Combusting fuel in first combustion chamber (02) is thrusting to second combustion chamber (12) through open/shut device opening (07) and is combusting the second fuel in second combustion chamber (12) by its high temperature and pressure. The subsequent simultaneous combustions in both cylinders (01, 11) push their pistons (04, 14) down to revolve the crankshaft (06). The top opening (07) of the open/shut device is closed immediately after the combustion happens. FIG. 1d shows the crankshaft (06) keeps on revolving and pushes the pistons (04, 14) to exhaust their exhaust gases from their emission apertures (09, 19).

This four-stroke cycle is working by two combustions in two cylinders but running together with one common crankshaft (06) system. Fuel one in cylinder (01) is a regular fuel with a regular internal combustion engine system. Fuel two in cylinder (11) can be any flammable fuel such as kerosene, diesel, plantation oil, or non-flammable carbon dioxide, hydrocarbon, and even water. These non-flammable fuels can be used as fuel because their flammable elements carbon, hydrogen and oxygen, are dissociated to their original form by the combusting high temperature and pressure in a closed combustion chamber. The sizes of the two cylinders are varied for different requirements of heat and pressure of different fuels. Fuel two in different cylinders of second cylinder (11) can be varied as required because they are not ignited by their sparks but burn and are combusted by the high temperature and pressure of fuel one.

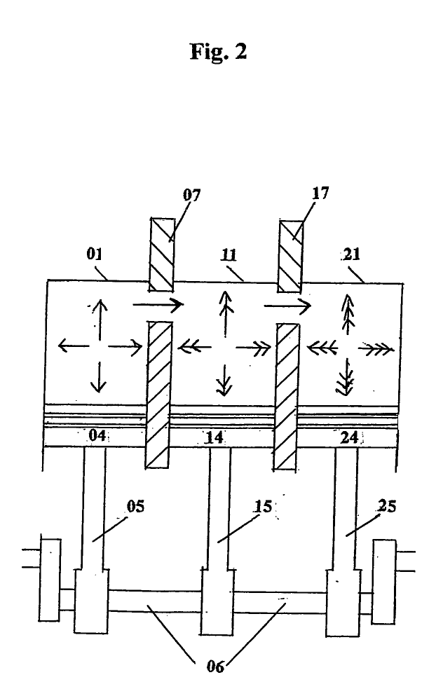

FIG. 2 shows an example of three consecutive cylinders for three different fuels in use at the same time. It shows fuel 1 in cylinder (01) is combusting and thrusting to second cylinder (11) causing fuel 2 to combust, and then thrusting to third cylinder (21) causing fuel 3 to combust as well. The open/shut devices in between with the top openings (07, 17) are opened. As three connecting rods (05, 15, 25) are connected to a common crankshaft (06), three fuels are working together to push three pistons (04, 14, 24). Their connecting rods with the common crankshaft (06) receive the combustion power to run the engine. Other strokes of intake, compression and exhaustion are working in the same manner as FIGS. 1a to 1d with the open/shut devices closed. This embodiment is showing that more different kinds of fuel can be used in the invention on the condition that fuel one has enough heat and pressure to combust the other fuels.

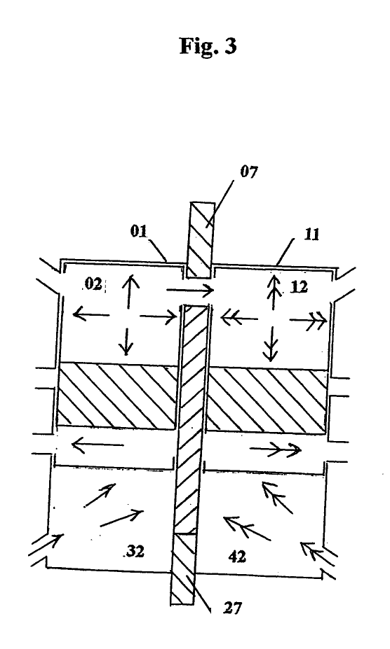

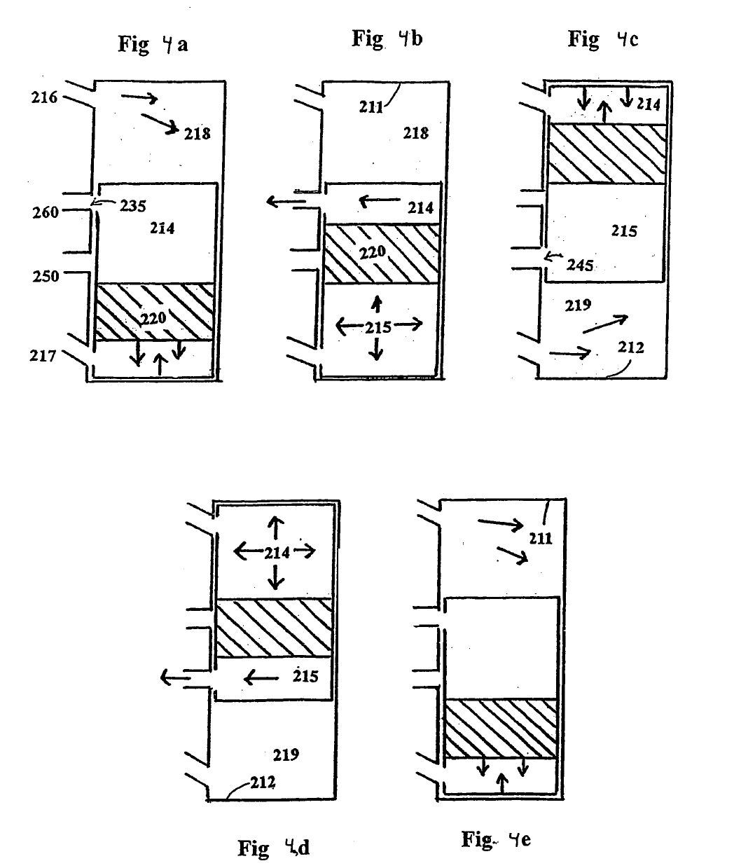

FIG. 3 shows an example of the invention applied to a non-conventional internal combustion engine shown in FIGS. 8a to 8e of U.S. patent application Ser. No. 10/123,402 entitled Internal Combustion Engine. Those figures are reproduced as FIGS. 4a to 4e herein. Referring thereto, an internal combustion engine can have two combustion chambers on the top and bottom of the same cylinder separated by a mutual piston. FIG. 3 illustrates the present invention applied to my prior invention of that earlier application, in the state corresponding to FIG. 4d. This invention of a multi-fueled internal combustion engine is applied to two cylinders (01, 11) of my previous invention adjacent to each other, but having an open/shut device built in between, with the top opening (07) opened for two fuels in two top combustion chambers (02, 12) combusting together. At the same time, a lower opening (27) of the open/shut device is closed for two fuels taken into two lower combustion chambers (32, 42) for subsequent combustions. This embodiment shows this invention can be applied to any or most internal combustion engine designs by putting two combustion chambers of two cylinders adjacent to each other with an adequate open/shut device in between.

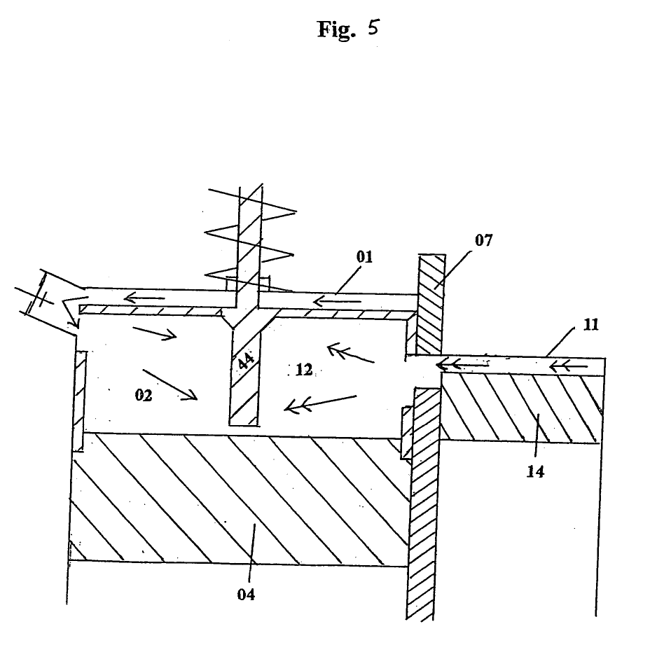

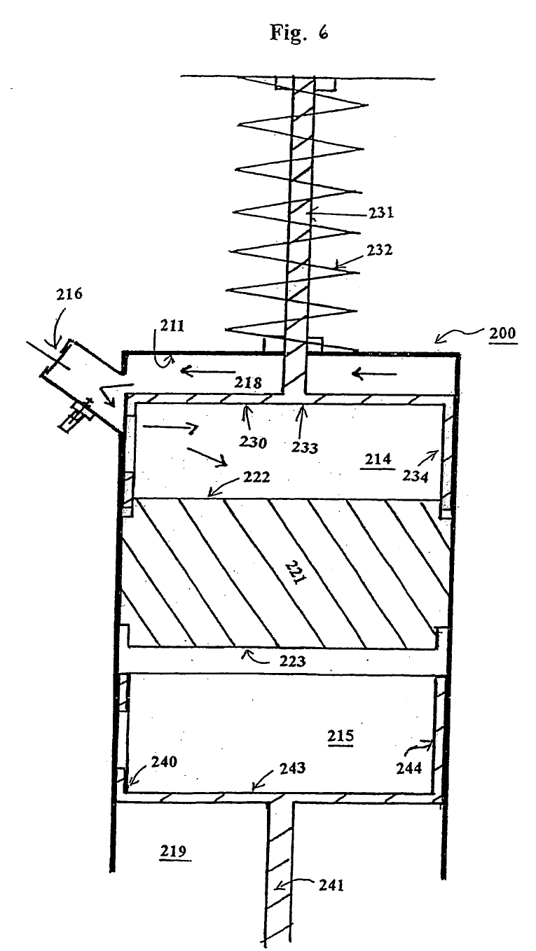

FIG. 5 shows an example of the invention applied to the embodiment of FIG. 2 of U.S. patent application Ser. No. 10/123,402, which is reproduced as FIG. 6 herein. In this implementation, the single cylinder design of FIG. 6 is provided with a new subordinate cylinder. Two fuels are taken into the same cylinder (01) where fuel 1 is taken into one side (02) of the combustion chamber from cylinder (01) itself and fuel 2 is taken into the other side (12) of the same chamber from the subordinate cylinder (11). These two sides (02, 12) of the same combustion chamber work as two different combustion chambers separated by a partition wall (44). The proportion of the two sides for the partitioning of the combustion chamber can be varied according to the different quality and quantity of the two fuels. These two fuels are going into their own sides without mixing. On combusting of fuel 1 or fuel 2, the explosion will push the piston down and thrust over the partition wall 44 into the other side, thus combusting the other fuel to produce a joint combustion effect. This embodiment can have the same function as the other embodiments but has a smaller design whereas only a partitioned combustion chamber is required. The piston (14) of the subordinate cylinder (11) is working in collateral with piston (04) of main cylinder (01). An open/shut device is built in between to separate the two cylinders (01, 11). A top opening (07) has opened for transfer of compressed fuel and is closed for combustion, exhaustion and intake. The lower part of the same cylinder of FIG. 6 in my previous invention should be treated in the same manner as mentioned above.

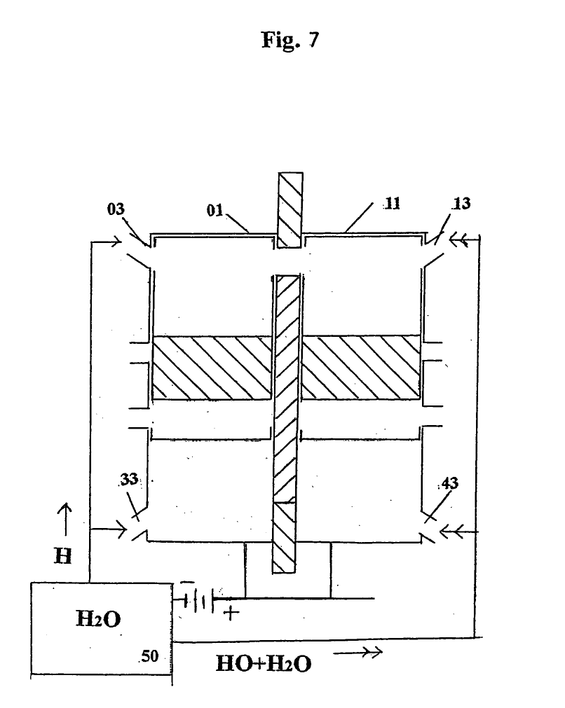

FIG. 7 shows a simplified figure of an example for utilizing water as the fuel of an internal combustion engine in my invention. The main internal combustion engine working process of the four-stroke cycle is the same as depicted in FIG. 3. FIG. 7 shows that an additional electrolysis device (50) is installed and receives electric current from the engine or engine-dynamo. The electricity supplied is converting water (H₂O) in the device (50) into hydrogen (H) and remaining (HO). Hydrogen produced will be directed to cylinder (01) through its fuel intake apertures (03, 33) as fuel 1 for ignition to combustion. The remaining HO with water will be directed to cylinder (11) through its fuel intake apertures (13, 43) as fuel 2 to be combusted by hydrogen as fuel 1. As hydrogen has a burning temperature of 2,300-3,000 degrees C., this extreme high temperature with pressure can dissociate water droplets, steam, or water vapor into their original elements: hydrogen and oxygen, thus producing a subsequent burn and combustion. This embodiment can have the same function as the other embodiments but using water as an only fuel.

It is important to understand that the burning of water is a process absorbing a lot of heat to reach 500 degrees C. before burning and generating heat, but the high temperature resulting from the burning of hydrogen can be varied according to different factors: pressure, purity of air involved, and the like. Consequently, the proportion, pressure and fineness of water vapor taken into the chambers for combustion is necessary to calculate and control. A simple calculation is to take the temperature of the combustion of hydrogen and divide it by 800, supposing 800 degrees C. is the best engine temperature before cooling and easily combusts the water vapor. The divided result is the proportion of water. For example: Temperature of hydrogen combustion is 3200 degrees, and divided by 800 produces a result of 4. Therefore the proportion of water to hydrogen is roughly 3:1, totaling 4 which is the same as the divided result.

In considering the effects from the heat taken in and given out from the combustion of water, a simple equation for calculation is derived. From the previous example, it was found that:

4=3200/800 if effect of water is zero.

It can be broken up as:

1+3=(3200+0)/800.

Supposing in a new example: temperature of hydrogen (H) is 1600, best engine temperature (E) is 800, temperature of combustion water given out (WO) is 900 and taken in (WI) is 500, proportion of water (P) is to be determined. Therefore, the equation for proportion of water is 1+P=(H+(WO−WI)P)/E.

It can be solved as:

1+P=(1600+(900−500)P)/800.
800+800P=1600+400P.
   Therefore:
400P=800,
P=2.
   Proportion for water to hydrogen is 2 to 1 for this example.

Devices for setting, adjusting and tuning the appropriate proportionate volumes of water and hydrogen consumed in the respective cylinders are required to produce a satisfactory combustion result. Too much water would cause stalling of the engine as the temperature would be too low for burning of such water, but an insufficient amount of water means more hydrogen is required to be produced and consumed by the engine. Burning of too much hydrogen would cause overheating of the engine. Production of hydrogen is a heavy burden for an internal combustion engine, in addition the engine has not only to produce hydrogen but to carry out its normal working duty. Therefore an efficient internal combustion engine, a good water electrolysis device system and an accurate calculation of the amount of water are important to this embodiment of the invention.

Of course, it is not required to have hydrogen as the only fuel to burn water and there are some other fuels easier and cheaper than hydrogen which have a good burning temperature to burn water. And also, there are some other ways to get a supply of hydrogen such as: refilled from gas stations, by other engine, or run the engine overnight to top up the hydrogen tank be used on the next day for normal working.

1. An internal combustion engine including at least two engine cylinders, said cylinders being adjacent to each other at their combustion chambers with at least one common passage in between, each said cylinder have their own piston member and connecting rod connected to a common working shaft.

2. The engine of claim 1, further including an open/shut member in the common passage between two adjacent cylinders.

3. The engine according to claim 2, further including an opening member as a part of the open/shut member allowing said cylinders to combust at the same time when opened and shut at all other times for different fuels.

4. The engine of claim 1, further including a partition wall built in one combustion chamber partitioning said combustion chamber into two different parts of a cylinder.

5. The engine according to claim 4, further including an opening member as a part of the open/shut member allowing said different parts of the combustion chamber to be filled up with two different compressed fuels when opened and shut at all other times.

6. The engine of claim 1, including a converting member to obtain hydrogen from hydrolyzing water as one fuel in one combustion chamber and combusting remaining water as another fuel in the other combustion chamber.

7. The internal combustion engine including at least two cylinders adjacent to each other, said cylinders having a common passage with an open/shut member in between, wherein said open/shut member opens during combustion to allow two combustion chambers to combust at the same time for different fuels,
said engine being built with a water converting member to combust hydrogen and water at the same time as an engine fueled by water.
